(19) United States
(12) Patent Application Publication
(10) Pub. No.: US 2025/0165125 A1
(43) Pub. Date: May 22, 2025

(54) METHODS AND DEVICES FOR EXPLORING AN N-DIMENSIONAL EMBEDDING SPACE USING A NAVIGATION-BASED RECOMMENDER

(71) Applicant: Shopify Inc., Ottawa (CA)

(72) Inventors: Russ MASCHMEYER, Berkeley, CA (US); Eric Andrew FLORENZANO, San Francisco, CA (US); Brennan LETKEMAN, Calgary (CA); Melanie BERENDS, Chicago, IL (US); Diego Macario BELLO, Montreal (CA); Daniel BEAUCHAMP, Toronto (CA)

(21) Appl. No.: 18/516,112

(22) Filed: Nov. 21, 2023

(51) Int. Cl. G06F 3/0484; G06F 3/0482; G06Q 30/0601

(52) U.S. Cl. CPC G06F 3/0484; G06F 3/0482; G06Q 30/0641

(57) ABSTRACT

A method and apparatus is provided to allow a user to explore an n-dimensional embedding space using a recommender system, including a navigational UI. A set of n-dimensional embeddings from an n-dimensional embedding space may be transformed into a set of lower dimensional embeddings, based on a dimensionality reduction. The set of lower dimensional embeddings may be processed to generate a configuration of spaced items, and a signal may be transmitted to cause a display of a remote user device to output the navigational user interface (UI) having a plurality of selectable items according to the configuration of spaced items, the plurality of selectable items corresponding to lower dimensional embeddings of the set of lower dimensional embeddings. The disclosed method and apparatus may enable improved user interaction with an e-commerce website while browsing through dense product spaces.

### FIELD

The present disclosure relates to machine learning, and, more particularly, to recommender systems, and, yet more particularly, to a navigation-based recommender system for exploring an n-dimensional embedding space and a navigational user interface thereof.

### BACKGROUND

Users interact with e-commerce websites to find desired products. Users may browse through product listings on an e-commerce website based on a category structure, and may narrow the product listings by applying filters according to attributes or characteristics of the desired product. Products in a product space may be associated with a large number of attributes or characteristics. Product embeddings encode product attributes in a way that also captures a similarity between products.

### SUMMARY

A method and apparatus for outputting a navigational user interface (UI) having a plurality of selectable items, to a display of an electronic device, are provided. In examples, a user may interact with the navigational UI to explore an n-dimensional embedding space, such as a product space on an e-commerce platform. The dimensionality of the product space can be very large because of the large number of possible product features that are represented in the product space. Currently, users interact with e-commerce websites to find desired products in many ways, for example, by performing a search query for a desired product, by clicking on an inbound link (e.g., an advertisement) or by browsing through product listings on a website. Browsing products (or other objects) in a product space of n-dimensional embeddings is inefficient due to the overwhelming volume of choices.

Existing systems for exploring a product space attempt to narrow product choices to better match user preferences, for example, using filters, search queries or recommendation engines. Some existing recommenders often suggest a fixed set of products that may be related to a “current” product that a user is browsing, however these recommendations are often too narrow and fail to represent nuances in the attributes or combinations of desired features that a user is seeking in a product. Product embeddings may be used to narrow product choices more effectively, or to recommend adjacent or affiliated products to a buyer. As products in a product space are typically associated with a large number of attributes, associated product embedding spaces can have high dimensionality, posing challenges for analyzing and navigating through the high dimensional data. As dimensionality increases, data can become sparse, requiring greater volumes of data and increased storage to accommodate the data, while also increasing computational complexity.

In various examples, the present disclosure provides a technical solution that automatically reduces the dimensionality of the product space and provides a navigational environment conducive to targeted browsing. Given a set of n-dimensional embeddings, the technical solution applies a dimensionality reduction to reduce the set of n-dimensional embeddings to a set of lower dimension embeddings, and then applies a quantization algorithm to arrange at least a subset of the lower dimension embeddings into a spaced configuration of selectable items. In examples, the spaced configuration may represent a compacted configuration, where all areas of the compacted configuration contain selectable items, thereby avoiding the unnecessary use of processing power to render empty regions of the lower dimensional map and helping to optimize the navigation inputs. Avoiding blank spaces in the spaced configuration also improves user browsing experience.

In examples, the solution includes a navigational UI for navigating the configuration in evenly-spaced jumps. The solution provides a benefit of an easy to use and flexible UI that enables users to browse adjacent products in the product space or navigate the configuration in a way that preserves relationships between similar products, to make it easier for users to identify adjacent products that they may be interested in. The technical solution also may customize the dimensionality reduction based on an input from a user, for example, based on whether the user wants to explore “similar” products or “co-purchased” products, among other categories or relationships present in the original data. In this regard, the disclosed solution may improve the performance of e-commerce platforms or merchant websites by presenting an improved browsing experience to specific users in a manner that is more relevant and appealing to the user, thereby reducing the number of navigational inputs and intermediate navigational pages required and reducing the use of computing resources (e.g., processing power, memory, computing time, etc.) for navigating to a desired product page.

In some examples, the present disclosure describes a computer-implemented method. The method includes a number of steps. The method comprising: transforming an n-dimensional embedding from an n-dimensional embedding space to a lower dimensional embedding space, the n-dimensional embedding space containing a set of n-dimensional embeddings and the lower dimensional embedding space containing a set of lower dimensional embeddings transformed from at least a subset of the set of n-dimensional embeddings including the first n-dimensional embedding; processing the set of lower dimensional embeddings to generate a configuration of spaced items; and transmitting a signal to cause a display of a remote user device to output a navigational user interface (UI) having a plurality of selectable items according to the configuration of spaced items, the plurality of selectable items corresponding to lower dimensional embeddings of the set of lower dimensional embeddings.

In an example of the example preceding method, the configuration of spaced items is a configuration of compacted items.

In an example of the example preceding method, the configuration of compacted items has a centroid item at the center of the configuration of compacted items.

In an example of the example preceding method, the method may further include: prior to transforming the n-dimensional embedding from the n-dimensional embedding space to the lower dimensional embedding space: obtaining a first n-dimensional embedding corresponding to a first selected item, the n-dimensional embedding being in an n-dimensional embedding space, wherein the first-n dimensional embedding corresponds to the centroid item.

In an example of the example preceding method, wherein transforming the n-dimensional embedding space to the low dimensional embedding space may include: applying a dimensionality reduction on the n-dimensional embedding space based on one or more features of the first n-dimensional embedding, to generate the low dimensional embedding space.

In an example of the example preceding method, wherein the dimensionality reduction is: a t-distributed stochastic neighbor embedding (t-SNE); a uniform manifold approximation and projection (UMAP); or a principal component analysis (PCA).

In an example of the example preceding method, wherein processing the set of lower dimensional embeddings to generate a configuration of spaced items may include: arranging the set of lower dimensional embeddings in an quantized grid configuration.

In an example of the example preceding method, wherein the lower dimensional embedding space is a 2D embedding space or a 3D embedding space.

In an example of the example preceding method, wherein a distance between a pair of low dimensional embeddings in the set of low dimensional embeddings represents a similarity measure for the pair of low dimensional embeddings.

In an example of the example preceding method, wherein a distance between a pair of low dimensional embeddings in the set of low dimensional embeddings represents a co-purchase measure for the pair of low dimensional embeddings.

In an example of the example preceding method, the method may further include: responsive to an input from the user device selecting a second selected item from the plurality of selectable items, updating the centroid to be the second selected item; updating the configuration of spaced items according to the updated centroid; and transmitting another signal to cause the display of the remote user device to update the navigational UI to display an updated plurality of selectable items according to the updated configuration of spaced items.

In an example of the example preceding method, wherein updating the configuration of spaced items may include: updating the low dimensional embedding space by applying a dimensionality reduction on the n-dimensional embedding space based on one or more features of a second n-dimensional embedding representing the second selected item, the updated low dimensional embedding space containing an updated set of low dimensional embeddings including the second n-dimensional embedding; and processing the updated set of low dimensional embeddings to generate the updated configuration of spaced items.

In some examples, the present disclosure describes a computer-readable medium storing instructions that, when executed by a processor of a computing system, cause the computing system to: transmit a signal to cause a display of a remote user device to output a navigational user interface (UI) having a plurality of selectable items according to the configuration of spaced items, the plurality of selectable items corresponding to lower dimensional embeddings of the set of lower dimensional embeddings.

In an example of the example preceding non-transitory computer-readable medium, wherein the configuration of spaced items is a configuration of compacted items.

In an example of the example preceding non-transitory computer-readable medium, wherein the configuration of compacted items has a centroid item at the center of the configuration of compacted items.

In an example of the example preceding non-transitory computer-readable medium, wherein the instructions, when executed by a processor of a computing system, further cause the computing system to: prior to transforming the n-dimensional embedding from the n-dimensional embedding space to the lower dimensional embedding space: obtain a first n-dimensional embedding corresponding to a first selected item, the n-dimensional embedding being in an n-dimensional embedding space, wherein the first-n dimensional embedding corresponds to the centroid item.

In an example of the example preceding non-transitory computer-readable medium, wherein the instructions, when executed by a processor of a computing system, cause the computing system to transform the n-dimensional embedding space to the low dimensional embedding space by: applying a dimensionality reduction on the n-dimensional embedding space based on one or more features of the first n-dimensional embedding, to generate the low dimensional embedding space.

In an example of the example preceding non-transitory computer-readable medium, wherein the dimensionality reduction is: a t-distributed stochastic neighbor embedding (t-SNE); a uniform manifold approximation and projection (UMAP); or a principal component analysis (PCA).

In an example of the example preceding non-transitory computer-readable medium, wherein the instructions, when executed by a processor of a computing system, cause the computing system to process the set of lower dimensional embeddings to generate a configuration of spaced items by: arranging the set of lower dimensional embeddings in an quantized grid configuration.

In some examples, the computer-readable medium may store instructions that, when executed by the processor of the computing system, cause the computing system to perform any of the methods described above.

In some examples, the present disclosure describes an apparatus including: a processing unit communicatively coupled to a display device, the processing unit being configured to execute computer-readable instructions to cause the system to: transform an n-dimensional embedding from an n-dimensional embedding space to a lower dimensional embedding space, the n-dimensional embedding space containing a set of n-dimensional embeddings and the lower dimensional embedding space containing a set of lower dimensional embeddings transformed from at least a subset of the set of n-dimensional embeddings including the first n-dimensional embedding; process the set of lower dimensional embeddings to generate a configuration of spaced items; and transmit a signal to cause a display of a remote user device to output a navigational user interface (UI) having a plurality of selectable items according to the configuration of spaced items, the plurality of selectable items corresponding to lower dimensional embeddings of the set of lower dimensional embeddings.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2 is a block diagram of an example computing system, which may be used to implement examples of the present disclosure;

FIG. 3 is a block diagram illustrating an example recommender system associated with an e-commerce platform, in accordance with example embodiments of the present disclosure;

FIG. 4 is a block diagram illustrating an example recommendation engine, in accordance with example embodiments of the present disclosure;

FIG. 5A shows an example configuration of a navigational user interface (UI), in accordance with an example embodiment of the present disclosure;

FIG. 5B shows an example configuration of a navigational UI, in accordance with an example embodiment of the present disclosure;

FIG. 6 is a flowchart illustrating an example method for outputting a navigational UI having a plurality of selectable items, to a display of an electronic device, in accordance with examples of the present disclosure;

FIG. 7 is a block diagram of an example e-commerce platform, which may be an example implementation of the examples disclosed herein; and

FIG. 8 is an example homepage of an administrator, which may be accessed via the e-commerce platform of FIG. 7.

Similar reference numerals may have been used in different figures to denote similar components.

### DETAILED DESCRIPTION

Complex datasets having many features or characteristics are considered to be high-dimensional data. While high-dimensional data contains a large volume of useful information, high-dimensional data can be difficult to use effectively. Processing high-dimensional data is computationally expensive, requiring large amounts of storage space, processing resources and time. Exploring or browsing a high-dimensional dataset is even more challenging, due to the overwhelming number of choices, while existing tools for filtering or searching through high-dimensional datasets are limited by a user's knowledge of a desired feature or relevant keywords for effectively narrowing down the selection.

The present disclosure describes a solution that automatically reduces the dimensionality of a complex, high-dimensional dataset, for improving the processing speed and efficiency of computing resources required to facilitate browsing or navigating a complex dataset. Processing a lower dimensional dataset to enable browsing or navigating a lower dimensional space can be performed with fewer processing, storage and memory requirements.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

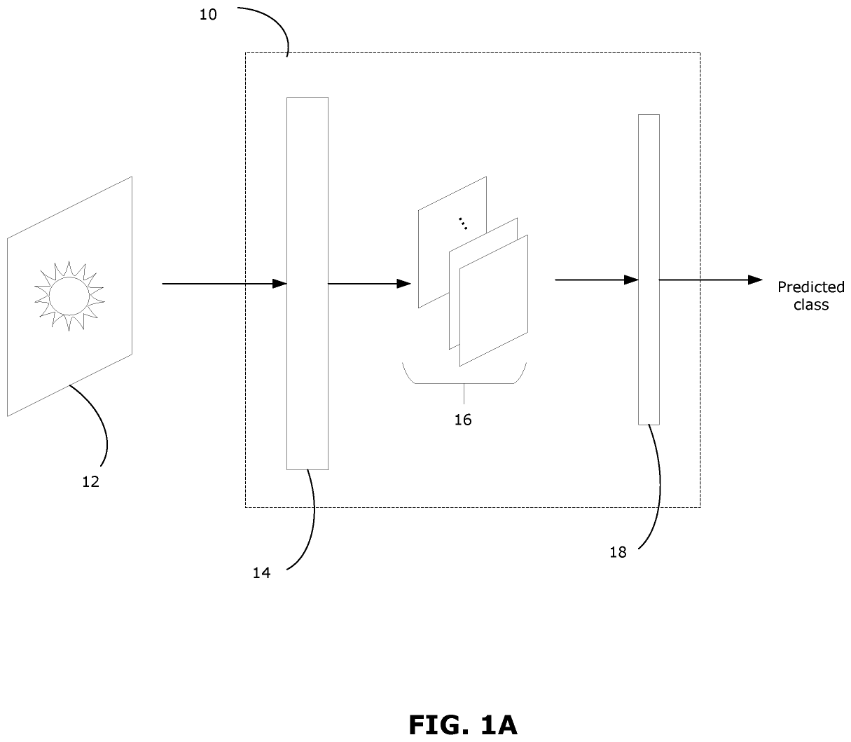

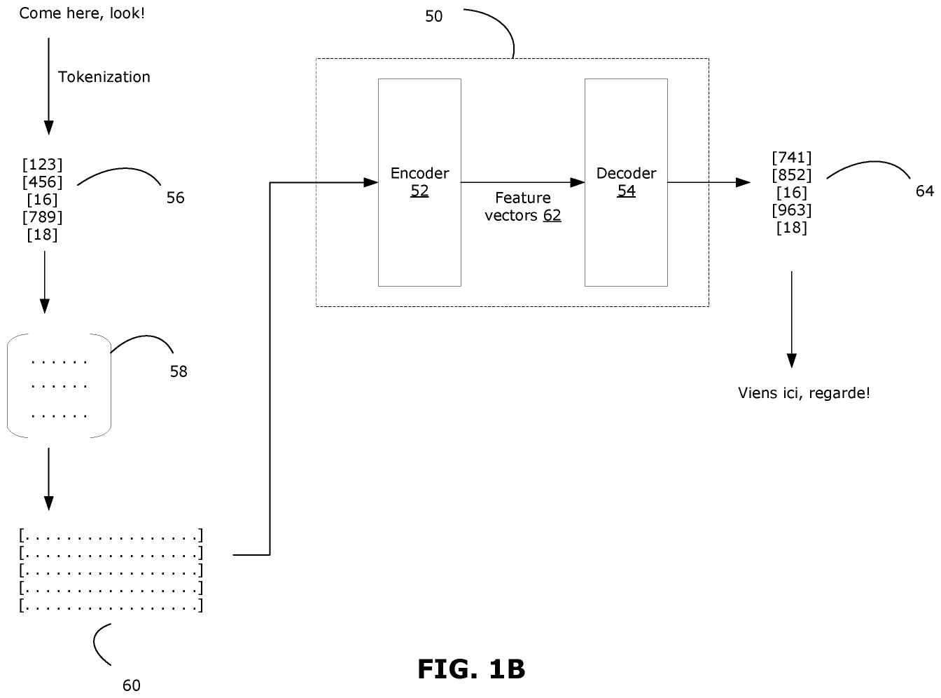

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space (or embedding space) may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Although described above in the context of language tokens, embeddings and feature vectors are also commonly used to encode information about objects and their relationships with each other. For example, embeddings and feature vectors are frequently used in computer vision applications for object detection and semantic understanding. Embeddings that represent objects may be found in an embedding space, where the similarity and relationship of two objects (e.g., similarity between a cat and a lion) may be represented by the distance between the two corresponding embeddings in the embedding space.

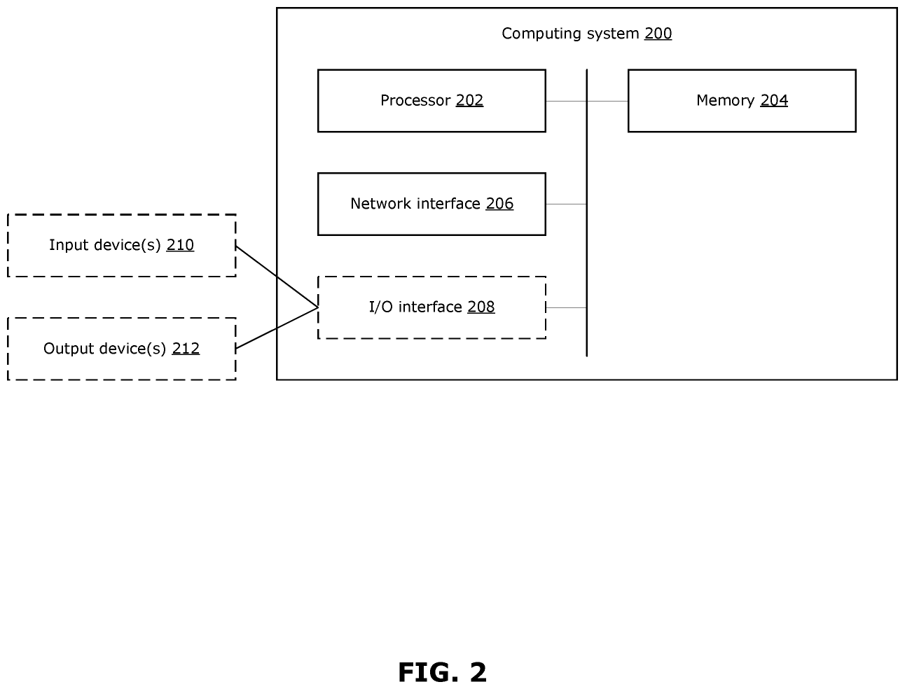

FIG. 2 illustrates an example computing system 200, which may be used to implement examples of the present disclosure, such as a recommender system 300 for generating object recommendations for exploring in a navigational UI. Additionally or alternatively, one or more instances of the example computing system 200 may be employed to execute the recommender system 300. For example, a plurality of instances of the example computing system 200 may cooperate to provide output using a recommender system 300 in manners as discussed above.

The example computing system 200 includes at least one processing unit and at least one physical memory 204. The processing unit may be a hardware processor 202 (simply referred to as processor 202). The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). A network interface may enable the computing system 200 to carry out communications (e.g., wireless communications) with systems external to the computing system 200.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a pointing device (e.g., a mouse, a stylus etc.), a keyboard, a camera, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

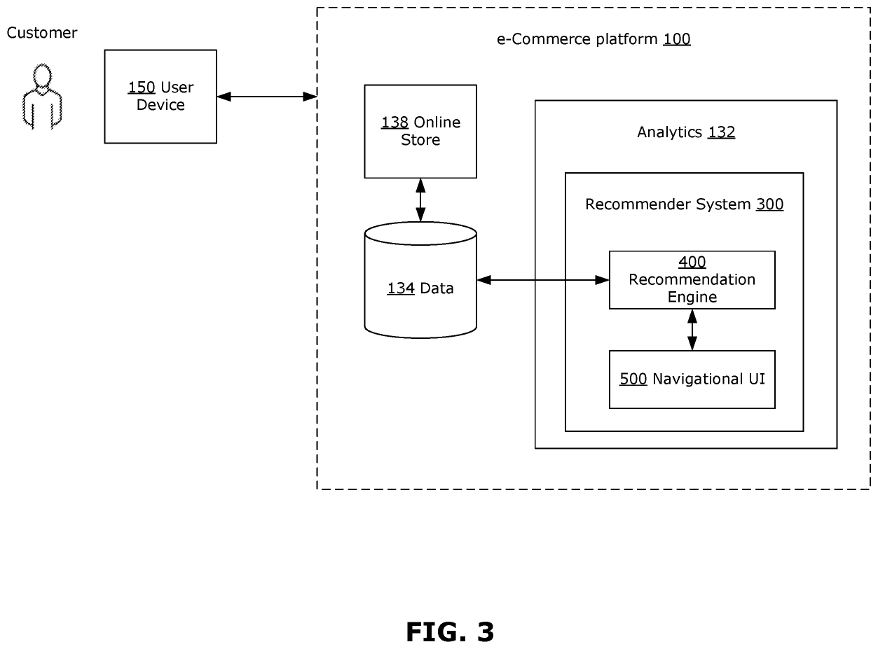

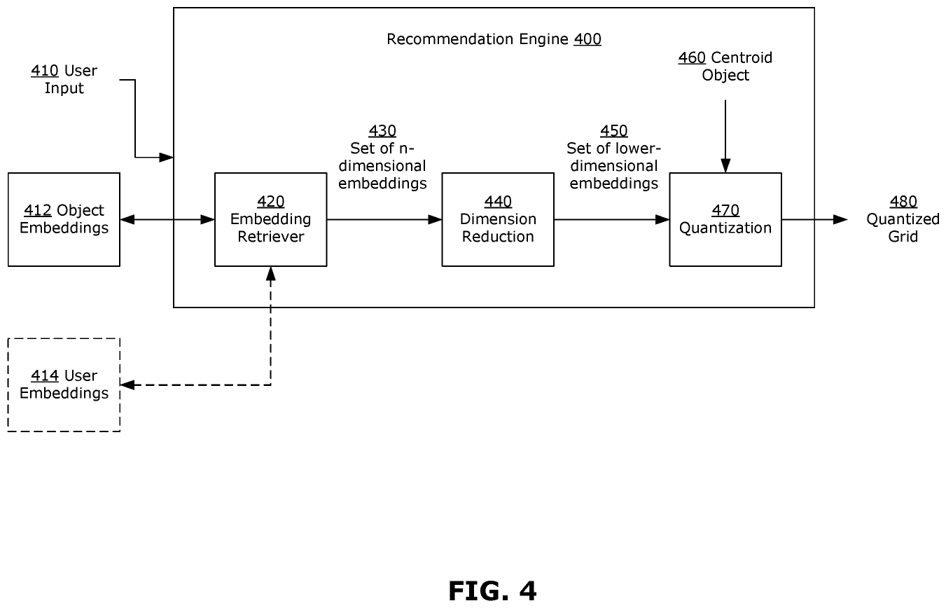

In the example of FIG. 2, the computing system 200 may store in the memory 204 computer-executable instructions, which may be executed by a processing unit such as the processor 202, to implement one or more embodiments disclosed herein. For example, the memory 204 may store instructions for implementing a recommender system 300 application, described with respect to FIG. 3 and FIG. 4 below. In some examples, the computing system 200 may be a server of an online platform that provides the recommender system 300 as a web-based or cloud-based service that may be accessible by a user device (e.g., via communications over a wireless network). Other such variations may be possible without departing from the subject matter of the present application.

FIG. 3 is a block diagram illustrating an example recommender system 300 of the present disclosure. The recommender system 300 may be a software that is implemented in the computing system 200 of FIG. 2, in which the processor 202 is configured to execute instructions for the recommender system 300 stored in the memory 204. The recommender system 300 includes a recommendation engine 400 and a navigational UI 500. In examples, the recommendation engine 400 is configured to cooperate with the navigational UI 500 for displaying a set of recommended objects on a display of a user device 105.

In various embodiments, an e-commerce platform includes information associated with products and/or services (e.g., objects) sold via the e-commerce platform, for example, through an online store 138. In examples, transactional data related to objects sold via the e-commerce platform 100, and/or related to user purchasing behavior may be stored in a database, for example, in a data facility 134. In examples, an e-commerce platform analytics facility 132 may process transactional data, or other data related to user behavior, stored in the data facility 134.

In examples, object data may be labeled by category. Additionally, instead of being labeled by category, the object data may be labeled by fields or types, for example, for describing one or more object attributes (e.g., object name, size, weight, dimensions, color, type, composition, features, specifications or other metadata etc.). Each object attribute of a given object may be stored as a text string (which may include one or more words). For example, each object may have at least an object attribute in the category [object name]. Additional object attributes may include attributes in categories such as [color], [owner], [size], etc. As an example, the object database 560 may store the following object attributes related to a chair: [object name]“ergonomic chair”, [color]“black”, [material]“leather”. Each attribute may have one or more possible values. For example, the material attribute of the chair product may have the value of “leather” or the value of “fabric”, among others. It should be noted that the data facility 134 may store other data related to each object, such as an image of the object, a user or account associated with the object, etc. In examples, an object may be a physical product, or an object may not be a physical product, but may be a location, or a digital product, or a service, among others, that a user may desire or have a need for and which may be described by one or more attributes.

In some embodiments, for example, the e-commerce platform 100 may also include information associated with users (e.g., user profile data) about a plurality of users or classes of users (e.g., cohorts). For example, the user profile data may include, for each user or cohort, data about one or more user attributes. In the present disclosure, the term “user attribute” should be understood to refer to characteristics, preferences and/or needs associated with a user (e.g., a buyer or a potential buyer) or of a cohort, group or category the user may be associated with. In examples, the characteristics of a user may relate to user demographics, for example, including age, height, geographical location, marital status, gender, skin type, body shape, income, socioeconomic status, life stage, level of education, hobbies, interests and the like. In examples, user attributes obtained from “demographic information” may help to answer the question “who is the buyer?”. Such attributes may be explicitly identified by the user (e.g., inputted in a profile) and/or may be implicitly determined based on the user's behavior (e.g., purchase history, viewing history, etc.). In examples, the characteristics of a user may also relate to user preferences, for example, related to past commerce events or transactions (e.g., historic purchases, past browsing history etc.) or past search events (e.g., search query, browser activity, ads clicked on etc.) over an unrestricted or extended timeframe. In examples, user attributes obtained from “user preference information” help to answer the question “what does the buyer like?” In examples, the characteristics of a user may also relate to user needs, for example, related to recent commerce events or transactions (e.g., recent purchases, recent browsing history, active cart etc.) or recent search events (e.g., search query, browser activity, ads clicked on etc.) within a more restricted and recent timeframe. In examples, user attributes obtained from “user need information” help to answer the question “what is the user's current need?”

User attributes for a given user or class of users may, for example, be stored in a lookup table that can be referenced using a unique identifier (e.g., a code, an identification number, an email address or other reference identifying the user, for example, a reference to the user's account or profile) of the user or cohort. Each user attribute of a given user or cohort may be stored as a text string (which may include one or more words).

In some embodiments, object attributes, and optionally, user attributes, may be provided to the recommender system 300 in the form of embeddings. In the present disclosure, “embeddings” can refer to learned representations of discrete variables as vectors of numeric values, where the “dimension” of the embedding represents the length of the vector. In some examples, embeddings may be referred to as embedding vectors. In examples, embeddings may represent a mapping between discrete variables and a vector of continuous numbers that effectively capture meaning and/or relationships in the data. In examples, embeddings may be represented as points in a multidimensional space, where data points exhibiting similarity are clustered closer together. In examples, embeddings may be learned for neural network models.

The data facility 134 may be accessed by the recommender system 300 as discussed further below. In some examples, the data facility 134 may not be stored locally on the computing system 200 but may instead be a remote database accessible by the computing system 200 (e.g., via a wired or wireless communication link, for example using the network interface 206). In accordance with examples of the present disclosure, the computing system 200 may be a server of an online platform (e.g., SaaS platform) that may provide services to a user device of the user (e.g., over a wireless network) to enable the user to browse a plurality of recommended objects on an e-commerce website.

FIG. 4 shows a block diagram of an example architecture for the recommendation engine 400, in accordance with examples of the present disclosure. The recommendation engine 400 may be a software that is implemented in the computing system 200 of FIG. 2, in which the processor 202 is configured to execute instructions of the recommendation engine 400 stored in the memory 204. The recommendation engine 400 includes a embedding retriever 420, a dimension reduction block 440, and a quantization block 470, and generates a quantized grid 480 of recommended objects. In examples, the recommendation engine 400 is configured to cooperate with a navigational UI 500 for displaying the recommended objects on a display of a user device 105.

In examples, a user input 410 may be received by the recommendation engine 400, for example, as a selection of an item (e.g., a product or another object) on a webpage of the e-commerce platform 100, among other inputs. In response to the user input 410, the embedding retriever 420 may query a database (e.g., data facility 134) of object embeddings 412 to obtain a set of n-dimensional embeddings 430, based on the selected item. In examples, included in the set of n-dimensional embeddings 430 may be an n-dimensional object embedding 412a corresponding to the selected item. Optionally, the embedding retriever 420 may query a database of user embeddings 414 to obtain a set of n-dimensional embeddings 430 associated with a current user profile or user account that is interacting with the e-commerce platform 100. In examples, the obtained set of n-dimensional embeddings 430 may define a corresponding n-dimensional embedding space, for example, where a centroid of the n-dimensional embedding space corresponds to the n-dimensional object embedding 412a.

In examples, a measure of similarity between each n-dimensional embedding may be represented by a distance between embeddings in the n-dimensional embedding space, for example, where embeddings exhibiting a higher degree of similarity may cluster together. In some embodiments, for example, the distance may be measured as a Euclidean distance, or another measure of distance may be used.

In examples, the n-dimensional embedding space may be considered as a high-dimensional embedding space. For example, common embedding sizes may include 512 dimensions or 1024 dimensions, among other embedding sizes, therefore is understood that an n-dimensional embedding space that is defined by n-dimensional embeddings of common sizes will be a large multi-dimensional space. As high-dimensional data can pose challenges for analysis and computational efficiency, a dimension reduction operation may be applied to the set of n-dimensional embeddings 430. In this regard, an embedding that has undergone a dimensionality reduction operation may be referred to as a lower dimensionality embedding. In some embodiments, for example, a lower dimensional embedding may refer to a 2D embedding, or a 3D embedding, among others.

Dimensionality reduction is the transformation of data (e.g., n-dimensional embeddings) from a high dimensional space into a lower dimensional space, where the lower dimensional representation of the data encodes some meaningful properties of the original data. In examples, the set of n-dimensional embeddings 430 may be input to a dimension reduction block 440 to transform the set of n-dimensional embeddings 430 into a set of lower dimensional embeddings 450.

In some embodiments, for example, the dimension reduction block 440 may perform dimensionality reduction using the t-distributed Stochastic Neighbor Embedding (t-SNE) approach. For example, t-SNE is a nonlinear technique that preserves the pairwise similarities or other relationships between data points in a lower dimensional space. In other embodiments, for example, the dimension reduction block 440 may perform dimensionality reduction using the Uniform manifold approximation and projection (UMAP) approach. For example, UMAP is a non-linear technique that tends to preserve global structure. In this regard, the choice of dimensionality reduction operation may depend on the type of data and/or the desired type of analysis, as different dimensionality reduction techniques focus on preserving different aspects of the data and its structure. For example, t-SNE clusters “groups” of related objects together while, UMAP separates them. In this regard, a user intending to explore multiple products within a single category may choose to perform dimensionality reduction using UMAP, whereas a user intending to browse products across categories may choose to perform dimensionality reduction using t-SNE. In other embodiments, for example, the dimension reduction block 440 may perform dimensionality reduction using Principal Components Analysis (PCA). For example, PCA is a linear technique where the data is transformed into a new coordinate system, where the axes represent dimensions that describe the largest variance in the data. In other embodiments, another dimensionality reduction operation may be used.

In examples, the set of lower dimensional embeddings 450 may be stored as one or more lower dimensional maps, for example, stored locally on the computing system 200, or stored remotely where it may be accessible by the computing system 200 (e.g., via a wired or wireless communication link, for example using the network interface 206). In examples, a lower dimensional map may be a 2D or a 3D map representation of the lower dimensional embedding space. In examples, multiple lower dimensional maps may be generated and stored, where each lower dimensional map may be generated using different source information (e.g., object embeddings 412 and/or user embeddings 414, or other embeddings corresponding to other data stored in the data facility 134). In other examples, multiple lower dimensional maps may be generated and stored, where each lower dimensional map may be generated using the same source information, but using a different dimension reduction operation.

In examples, the quantization block 470 may process the set of lower dimensional embeddings 450 to generate a configuration of spaced items, for example, a quantized grid 480 of lower dimensional embeddings representative of a set of recommended items. In some embodiments, for example, the quantized grid 480 may include a configuration of spaced items that preserves the spatial relationships between lower dimensional embeddings in the lower dimensional map. For example, in generating the quantized grid 480, the quantization block 470 may remove relative distances between data points in the lower dimensional map, while maintaining global distances between clusters of data points in an organized manner, such that adjacent spaced items or spaced items arranged in close proximity to each other may represent items having a higher measure of similarity, and where spaced items arranged far from each other may represent items having a lower measure of similarity.

Examples provided with respect to the configuration of spaced items in the quantized grid 480 are merely illustrative and are not intended to be limiting. It is understood that the arrangement of spaced items in the quantized grid 480 may take different forms, for example, where at least a subset of the set of lower dimensional embeddings 450 may be arranged in a variety of configurations, including, for example, a grid, a network, a framework, matrix or a mesh, among others. In examples, the quantized grid 480 may arrange at least a subset of the set of lower dimensional embeddings 450 according to a regularly shaped or an irregularly shaped grid of horizontal, vertical, radial, or other lines, where the lines may be parallel or may cross each other, or where the lines may be real or imaginary. In other examples, the quantized grid 480 may arrange at least a subset of the set of lower dimensional embeddings 450 according to a regularly shaped or an irregularly shaped grid comprising triangles, squares, rectangles or hexagons, among other parametric shapes. In other examples, the quantized grid 480 may be symmetrical or asymmetrical. In examples, the quantized grid 480 may include a radial arrangement of lower dimensional embeddings, or the arrangement of lower dimensional embeddings 450 may follow concentric circles, among other shapes and/or patterns.

In some embodiments, for example, the quantization block 470 may apply a compacting algorithm to the set of lower dimensional embeddings 450, for example, to generate the quantized grid 480 as a compacted configuration of lower dimensional embeddings. In some examples, the quantized grid 480 may be focused around the centroid object 460, where spaced items arranged adjacent to or in close proximity to the centroid object 460 may represent items having a higher measure of similarity to the centroid object (e.g., adjacent recommended items), and where spaced items arranged far from the centroid object 460 may represent items having a lower measure of similarity to the centroid object 460. In some examples, the centroid object 460 may represent a lower dimensional embedding corresponding to the n-dimensional object embedding 412a (e.g., corresponding to a selected item identified by the user input 410). In other embodiments, the centroid object 460 may represent another lower dimensional embedding from the set of lower dimensional embeddings 450.

In some embodiments, for example, the quantization block 470 may apply a circle packing algorithm (e.g., “circle packing in a plane”) to the set of lower dimensional embeddings 450, or another method may be used, to generate the quantized grid 480. In examples, a circle packing algorithm may arrange a plurality of circles (e.g., where each circle represents a respective lower dimensional embedding) within a circular boundary in a manner in which no two circles overlap and where at least some of the circles are mutually tangent. In other examples, the quantization block 470 may apply a square packing algorithm or a hexagonal packing algorithm, to the set of lower dimensional embeddings 450, or another algorithm may be used. In some embodiments, for example, the quantized grid 480 may be a configuration of evenly spaced lower dimensional embeddings. In other examples, the quantized grid 480 may not be evenly spaced.

In other embodiments, for example, the quantization block 470 may process the set of lower dimensional embeddings 450 according to an input received via the navigational UI 500. For example, the quantization block 470 may communicate with the navigational UI 500 to apply further dimension reduction to the set of lower dimensional embeddings 450, to generate a configuration of spaced items, based on user interaction with the navigational UI 500.

In examples, the recommender system 300 may send data to the user device 105 over a communication link (e.g., over a wireless network) to enable the quantized grid 480 of recommended items to be displayed on the user device 105. In examples, a signal may be transmitted to cause a display of a remote user device to output the navigational UI 500 having a plurality of selectable items according to the configuration of spaced items, for example, where the each of the plurality of selectable items corresponds to a respective lower dimensional embedding of the set of lower dimensional embeddings.

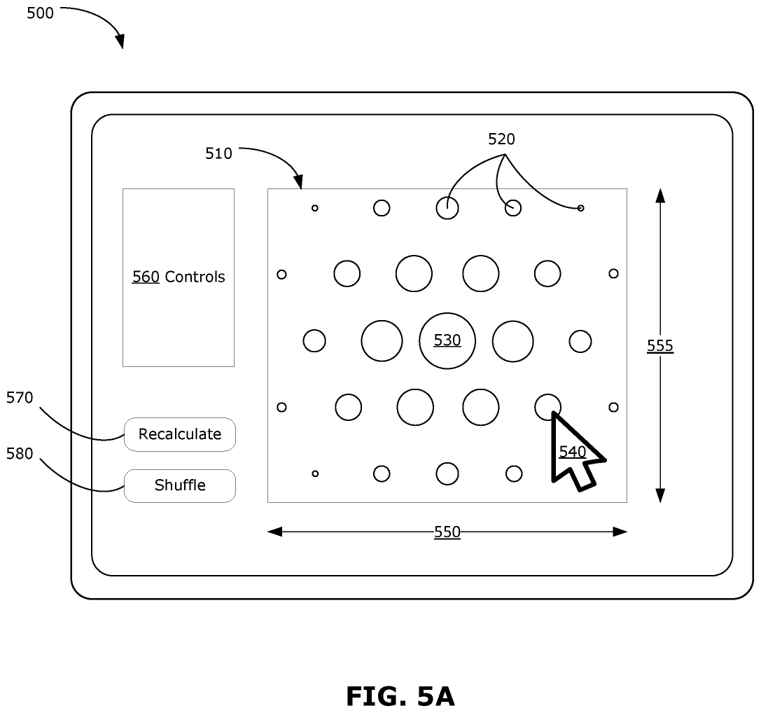

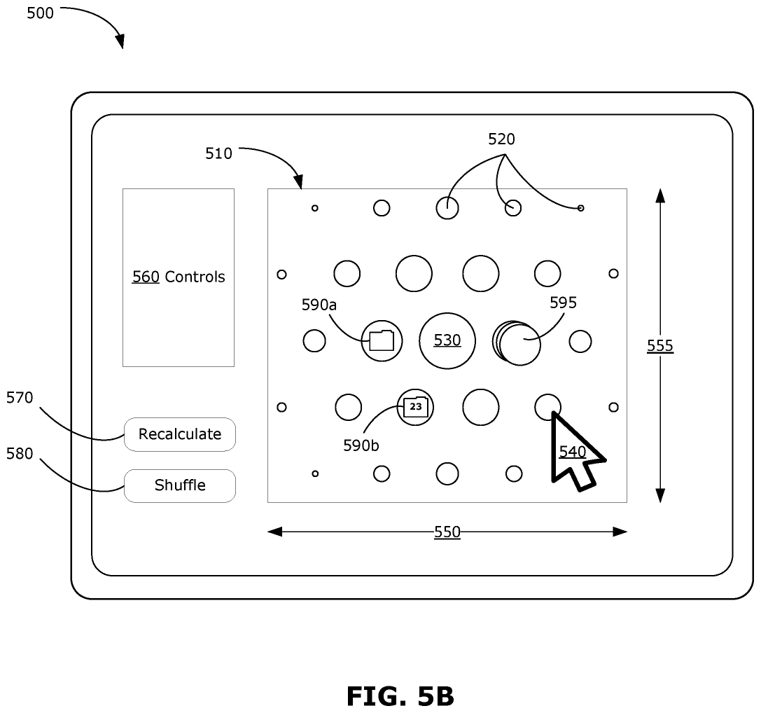

FIG. 5A shows an example configuration of a navigational UI 500, in accordance with an example embodiment of the present disclosure. In examples, the recommender system 300 provides a navigational UI 500, through which a user can explore, browse or navigate the reduced dimensional space. In examples, the navigational UI 500 may present a visualization of the lower dimensional map in a window 510, the visualization including a plurality of selectable items 520, according to the configuration of spaced items in the quantized grid 480. In examples, the plurality of selectable items 520 may be represented as icons or other virtual objects, for example, including a thumbnail image of a corresponding object (e.g., a product), if applicable. In examples, the plurality of selectable items 520 may be centered around a single item 530, for example, a “currently selected” or “current” item, or another item, and a direction of navigation can be chosen by the user in 2D or 3D space using one or more navigational actions. In some embodiments, for example, the navigational UI 500 may indicate the “current” item by displaying a virtual object or an image of the product at the center of the window 510 that is larger than other adjacent products, or another method of indicating the “current” item may be used.

In examples, a user may interact with the plurality of selectable items 520 in the low dimensional space using multiple navigational controls, for example, to “walk” or “jump” through the lower dimensional map. In examples, a user may navigate the lower dimensional map in window 510 with a pointing device 540 such as a mouse or a stylus, for example, using left-click, right-click, double-click, click-and-drag, scroll, among other mouse events to engage navigational controls, or using touch gestures (e.g., swipe, pinch, etc.) on a touch sensitive surface of an electronic device 150. For example, a click-and-drag event may enable a user to slowly drag the UI in a chosen direction to explore nearby items in a continuous manner (by “walking”) or in a discontinuous or discrete manner (by using “small jumps”) between spaced items in one direction, while a scroll event may cause the user to navigate faster (e.g., move faster in a continuous manner or “walk faster”; or move larger distances in a discrete manner or “jump farther” to spaced items at a pre-defined distance). In other examples, a touch gesture (e.g., pinch-closed gesture) on a touch sensitive surface may adjust the magnification level of the window 510, for example, allowing a user to zoom out and manipulate the low dimensional space to explore spaced items farther from the “current” item using larger navigational steps (“large jumps”) between items.

In examples, selecting one of the plurality of selectable items, for example, by clicking or double-clicking on the selectable item in the window 510 may set the newly selected item as the “current” item in the center of the window 510.

In some embodiments, for example, the direction of navigation may correspond to a particular dimension of the lower dimensional embedding space, for example, as determined by the dimensionality reduction operation. For example, a horizontal axis 550 or a vertical axis 555 of the window 510, among other axes, may correspond to a dimension associated with one or more object attributes. For example, a horizontal axis 550 could represent a dimension associated with “color saturation”, where navigating to the right of the “current” item may correspond to a subset of items having object attributes associated with the color “red”, whereas navigating to the left of the “current” item may correspond to a subset of items having object attributes associated with the color “blue”. In other examples, a vertical axis 555 could represent a dimension associated with “size”, where navigating up from the “current” item may correspond to a subset of items having object attributes associated with a larger size, whereas navigating down from the “current” item may correspond to a subset of items having object attributes associated with smaller size. The examples provided are merely illustrative, and it is understood that any axis could be associated with any dimension or attribute of the lower dimensional embedding space.

In some embodiments, the navigational UI may represent a quasi-2D space, where dimensions are adaptive to user navigation. For example, a user may further refine or filter the plurality of selectable items 520, for example, using controls 560. In examples, the controls 560 may include user interface elements including drop down menus, among other elements, for further refining the plurality of selectable items 520 in the navigational UI 500. For example, the controls 560 may provide options for filtering the lower dimensional embedding space by category or attribute. For example, a category selection box may be used to remove lower dimensional embeddings associated with a particular category or having other specific attributes, for example, “color”, “size”, “material”, etc. In other examples, user interface elements may be used to assign a direction of navigation to a particular dimension or category. In examples, in response to applying a filter to the lower dimensional space using controls 560, the navigational UI 500 may communicate with the recommendation engine 400 to update a corresponding quantized grid 480 accordingly, to reflect the removal of one or more lower dimensional embeddings from the set of lower dimensional embeddings 450.

In some embodiments, for example, the controls 560 may enable a user to customize the sensitivity of navigation, for example, to specify a the distance of a single discrete navigational step or the speed of a continuous navigational movement (e.g., a “distance” or a “velocity” associated with “walking” or “jumping”) through the lower dimensional space. For example, a user may configure certain navigational controls to represent higher or lower velocity navigational actions.

In some embodiments, for example, the controls 560 may enable a user to customize the dimensionality reduction operation. For example, a user may choose to apply a specific dimensionality reduction based on whether the user wants to explore “similar” products or “co-purchased” products, among other categories or relationships present in the original data. In examples, a user may choose to apply a UMAP dimensionality reduction when they are interested in browsing “similar” products, whereas they may choose to apply a t-SNE dimensionality reduction when they are interested in browsing “co-purchased” products, among others. In some examples, engaging with a “recalculate” element 570 after selecting a desired dimensionality reduction operation from the controls 560, may cause the recommendation engine 400 to reapply the dimensionality reduction to the n-dimensional set of embeddings, according to the specific dimensionality reduction operation, to generate a new lower dimensional map. In other examples, the controls 560 may enable a user to switch directly between lower dimensional maps that were each generated using a different dimensionality reduction operation and stored remotely or locally, for example, to view different distributions of spaced items or different spatial relationships between items, among others. In other embodiments, for example, the controls 560 may enable a user to customize the quantization operation that is applied to the set of lower dimensional embeddings 450.

In some embodiments, for example, a plurality of lower dimensional maps may be pre-generated and stored for one set of n-dimensional embeddings 430, for example, where each lower dimensional map is generated from the same set of n-dimensional embeddings 430 using a respective different dimensionality reduction operation. In examples, the plurality of lower dimensional maps may be stored in a remote database (e.g., cached in a database). In examples, when a user interacts with the navigational UI 500, (e.g., using the controls 560) and provides input indicating a request for a different lower dimensional map in the navigational UI 500, the remote database may be queried to obtain the nearest pre-computed lower dimensional embeddings to the current view in the navigational UI 500, for example, for presenting a new visualization of selectable items 520 in the navigational UI 500. In other embodiments, the plurality of lower dimensional maps may be stored locally, for example, downloaded to an electronic device, and in response to input indicating a request for a different lower dimensional map in the navigational UI 500, the nearest pre-computed lower dimensional embeddings may be obtained from a storage of the electronic device, for example, for presenting a new visualization in the navigational UI 500.

In some embodiments, for example, the navigational UI 500 may automatically configure the dimensionality reduction operation based on a user input, such as the user's most recent navigation action. For example, if a user is quickly scrolling to navigate the lower dimensional map at a high velocity (e.g., performing large “jumps” across the lower dimensional map), the navigational UI may infer that the user wishes to explore items across a range of categories and may automatically configure the dimensionality reduction operation to t-SNE. In another example, if a user presses a keyboard arrow to navigate the lower dimensional map at a low velocity (e.g., performing small “jumps” across the lower dimensional map), the navigational UI may infer that the user wishes to explore items having a high measure of similarity, and may automatically configure the dimensionality reduction operation to UMAP. In other examples, the navigational UI may configure the dimensionality reduction operation to apply another dimension reduction operation, based on a different user input.

In some embodiments, for example, selecting a new selectable item while navigating a lower dimensional map in the navigational UI 500 may configure the newly selected item as the “current” item, for the purpose of exploring the lower dimensional space. For example, selecting a new item as the “current” item may cause the recommendation engine 400 to automatically configure the centroid object 460 to match the new “current” item, for the purposes of performing the quantization operation 470. In some examples, the recommendation engine 400 may automatically perform the quantization operation 470 to center around the new “current” item. In other examples, engaging with the “recalculate” element 570 after selecting a new “current” item may cause the recommendation engine 400 to perform the quantization operation 470 to center around the new “current” item.

In some embodiments, for example, an element of randomness may be introduced into the navigational UI 500, for example, to shuffle the arrangement of spaced items within the window 510. For example, selecting a “shuffle” element 580 in the navigational UI may introduce some variation or interest among a pool of similar items in the plurality of spaced items.

FIG. 5B shows an example configuration of a navigational UI 500, in accordance with an example embodiment of the present disclosure. In some embodiments, for example, a cluster of spaced items having very similar attributes may be collapsed into a single object (e.g., a single selectable item 520) in the plurality of selectable items, for example, to enable viewing more product variety in the navigational UI. For example, a group of items representative of a cluster of similar items, for example, being separated by a distance (e.g., a Euclidean distance) in the n-dimensional embedding space or in the lower dimensional embedding space, that is lower than a threshold distance, may be collapsed into a subset of items. For example, the collapsed object may include a visual indicator, for example, a folder icon 590a may indicate that the object contains a subset of items that have been grouped according to some parameter. In other examples, a number 590b may serve as a visual indicator for indicating the number of items contained in the subset. In other examples, the selectable items may appear to be stacked 595, or another method may be used to indicate that the object contains a subset of items that have been grouped according to some parameter. In examples, the collapsed object may be expanded to enable viewing of all of the items in the cluster. For example, a user may select the object to expand the subset for viewing in the window 510.

It should be appreciated that the operations performed by the recommender system 300 to generate a set of recommended items for navigation in a navigational UI should be performed in real-time or near real-time. For example, there should be negligible delay (e.g., a time delay of no more than a few 100 ms) between receiving a user input 410 by the recommendation engine 400 and outputting a navigational UI 500 to a display on a user device.

In some embodiments, for example, the navigational UI 500 may be configured for a 3D virtual reality (VR) experience, for example, where the set of lower dimensional embeddings 450 or the quantized grid 480 of recommended items may be imaged as a 3D map where a user may navigate the 3D map using VR equipment (e.g., Apple Vision PRO™). In examples, a user wearing a VR headset may explore the 3D map by walking through the space. In examples, a user may interact with items in the 3D map using gestures, for example, using mid-air hand gestures such as pinch, wave, point etc., to select an object or to jump through the 3D space in a specific direction, among others.

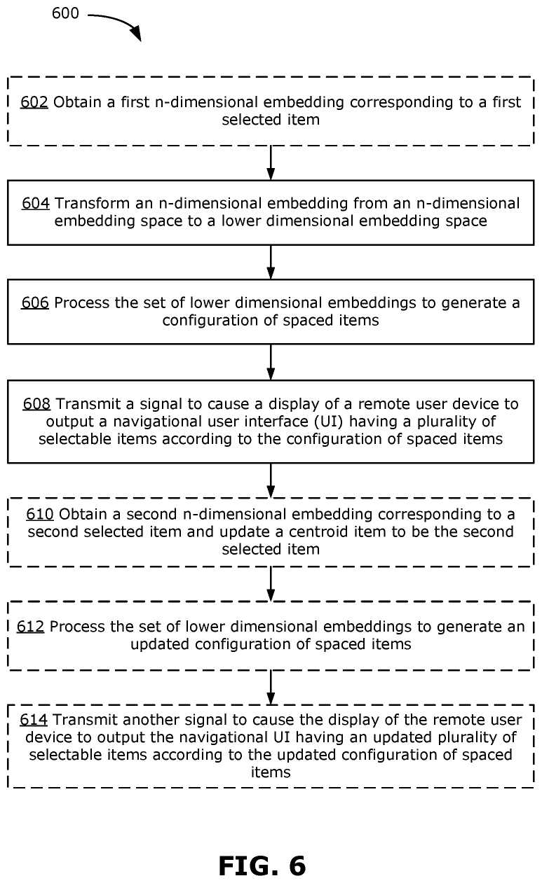

FIG. 6 is a flowchart of an example method 600 for outputting a navigational UI 500 having a plurality of selectable items, to a display of an electronic device, in accordance with examples of the present disclosure. The method 600 may be performed by the computing system 200. For example, a processing unit of a computing system (e.g., the processor 202 of the computing system 200 of FIG. 2) may execute instructions (e.g., instructions of the recommender system 300) to cause the computing system to carry out the example method 600. The method 800 may, for example, be implemented by an online platform or a server.

Optionally, at an operation 602, a first n-dimensional embedding corresponding to a first selected item may be obtained. In examples, the first n-dimensional embedding may be in an n-dimensional embedding space.

At an operation 604, an n-dimensional embedding may be transformed from an n-dimensional embedding space to a lower dimensional embedding space, where the n-dimensional embedding space contains a set of n-dimensional embeddings 430 and the lower dimensional embedding space containing a set of lower dimensional embeddings 450 transformed from at least a subset of the set of n-dimensional embeddings 430 including the first n-dimensional embedding. In examples, the n-dimensional embedding may be transformed by applying a dimensionality reduction to the n-dimensional embedding based on one or more features of the first n-dimensional embedding.

At an operation 608, the set of lower dimensional embeddings 450 may be processed to generate a configuration of spaced items. In examples, the configuration of spaced items may be represented by a quantized grid 480 centered around a centroid item 460, for example, where the first-n dimensional embedding corresponds to the centroid item 460.

At an operation 608, a signal may be transmitted to cause a display of a remote user device to output a navigational user interface (UI) having a plurality of selectable items according to the configuration of spaced items, the plurality of selectable items corresponding to lower dimensional embeddings of the set of lower dimensional embeddings.

Optionally, at an operation 610, a second n-dimensional embedding corresponding to a second selected item may be obtained and the centroid item may be updated to be the second selected item. In examples, the second n-dimensional embedding may be in the n-dimensional embedding space.

Optionally, at an operation 612, the set of lower dimensional embeddings 450 may be reprocessed to generate an updated configuration of spaced items. In examples, the updated configuration of spaced items may be represented by an updated quantized grid 480 centered around the updated centroid item 460.

Optionally, at an operation 614, another signal may be transmitted to cause the display of the remote user device to output the navigational user interface (UI) having an updated plurality of selectable items according to the updated configuration of spaced items.

### An Example e-Commerce Platform

Although integration with a commerce platform is not required, in some embodiments, the methods disclosed herein may be performed on or in association with a commerce platform such as an e-commerce platform. Therefore, an example of a commerce platform will be described.

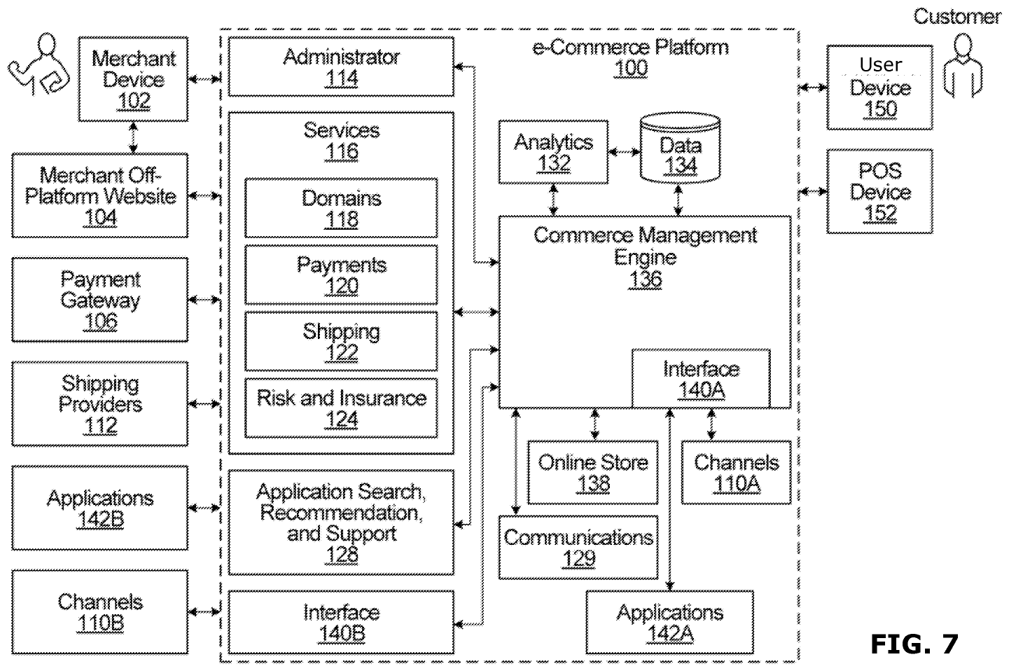

FIG. 7 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

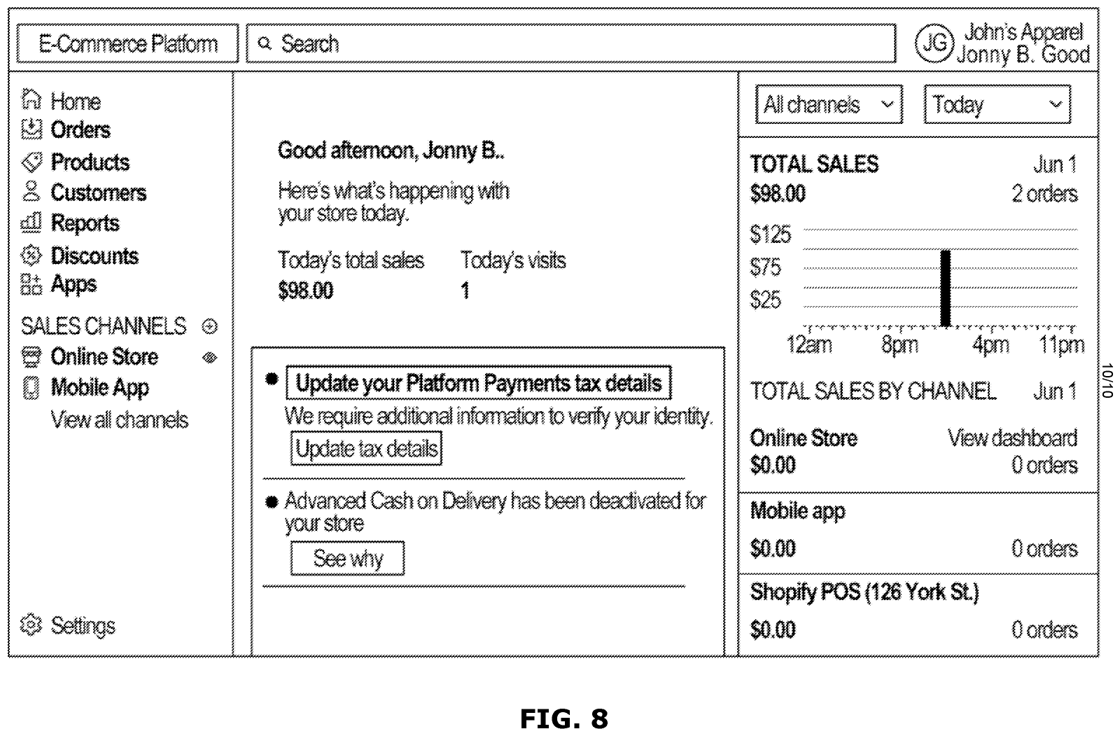

FIG. 8 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 3. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services, for example, in an analytics facility 132. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 2, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

The methods and systems (e.g., recommender system 300) as disclosed herein may be provided by the e-commerce platform as an online service to enable a user to conveniently and efficiently explore an n-dimensional embedding space, such as a product space. It should be understood that the methods and systems disclosed herein may be provided as an online service by any other online platform (e.g., SaaS platform) without being limited to the e-commerce platform. The online platform may provide applications that serve as an interface layer between the user and the recommender system, to enable the user to more effectively and efficiently make use of the recommender system to browse product listings.

Examples of the present disclosure may enable a navigation-based recommender system to output a navigational UI having a plurality of selectable items, to a display of an electronic device, based on product and/or user attributes (e.g., related to an individual user's preferences and needs, or characteristics of a desired product) as inputs. Examples of the present disclosure may enable a navigational user interface (UI) having a plurality of selectable items according to a configuration of spaced items to be automatically or semi-automatically generated, which may provide for greater efficiency and/or reduced need for user inputs. The disclosed solution may improve the performance of e-commerce platforms or merchant websites by presenting product listings to specific users in a manner that is more relevant and appealing to the user, thereby reducing the number of navigational inputs and intermediate navigational pages required and reducing the use of computing resources (e.g., processing power, memory, computing time, etc.) for navigating to a desired product page.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
transforming an n-dimensional embedding from an n-dimensional embedding space to a lower dimensional embedding space, the n-dimensional embedding space containing a set of n-dimensional embeddings and the lower dimensional embedding space containing a set of lower dimensional embeddings transformed from at least a subset of the set of n-dimensional embeddings including the first n-dimensional embedding;
processing the set of lower dimensional embeddings to generate a configuration of spaced items; and
transmitting a signal to cause a display of a remote user device to output a navigational user interface (UI) having a plurality of selectable items according to the configuration of spaced items, the plurality of selectable items corresponding to lower dimensional embeddings of the set of lower dimensional embeddings.

2. The method of claim 1, wherein the configuration of spaced items is a configuration of compacted items.

3. The method of claim 2, wherein the configuration of compacted items has a centroid item at the center of the configuration of compacted items.

4. The method of claim 3, further comprising:
prior to transforming the n-dimensional embedding from the n-dimensional embedding space to the lower dimensional embedding space:
obtaining a first n-dimensional embedding corresponding to a first selected item, the n-dimensional embedding being in an n-dimensional embedding space, wherein the first-n dimensional embedding corresponds to the centroid item.

5. The method of claim 1, wherein transforming the n-dimensional embedding space to the low dimensional embedding space comprises:
applying a dimensionality reduction on the n-dimensional embedding space based on one or more features of the first n-dimensional embedding, to generate the low dimensional embedding space.

6. The method of claim 5, wherein the dimensionality reduction is:
a t-distributed stochastic neighbor embedding (t-SNE);
a uniform manifold approximation and projection (UMAP); or
a principal component analysis (PCA).

7. The method of claim 1, wherein processing the set of lower dimensional embeddings to generate a configuration of spaced items comprises:
arranging the set of lower dimensional embeddings in an quantized grid configuration.

8. The method of claim 1, wherein the lower dimensional embedding space is a 2D embedding space or a 3D embedding space.

9. The method of claim 1, wherein a distance between a pair of low dimensional embeddings in the set of low dimensional embeddings represents a similarity measure for the pair of low dimensional embeddings.

10. The method of claim 1, wherein a distance between a pair of low dimensional embeddings in the set of low dimensional embeddings represents a co-purchase measure for the pair of low dimensional embeddings.

11. The method of claim 4, further comprising:
responsive to an input from the user device selecting a second selected item from the plurality of selectable items, updating the centroid to be the second selected item;
updating the configuration of spaced items according to the updated centroid; and
transmitting another signal to cause the display of the remote user device to update the navigational UI to display an updated plurality of selectable items according to the updated configuration of spaced items.

12. The method of claim 11, wherein updating the configuration of spaced items comprises:
updating the low dimensional embedding space by applying a dimensionality reduction on the n-dimensional embedding space based on one or more features of a second n-dimensional embedding representing the second selected item, the updated low dimensional embedding space containing an updated set of low dimensional embeddings including the second n-dimensional embedding; and
processing the updated set of low dimensional embeddings to generate the updated configuration of spaced items.

13. A computer-readable medium storing instructions that, when executed by a processor of a computing system, cause the computing system to:
transform an n-dimensional embedding from an n-dimensional embedding space to a lower dimensional embedding space, the n-dimensional embedding space containing a set of n-dimensional embeddings and the lower dimensional embedding space containing a set of lower dimensional embeddings transformed from at least a subset of the set of n-dimensional embeddings including the first n-dimensional embedding;
process the set of lower dimensional embeddings to generate a configuration of spaced items; and
transmit a signal to cause a display of a remote user device to output a navigational user interface (UI) having a plurality of selectable items according to the configuration of spaced items, the plurality of selectable items corresponding to lower dimensional embeddings of the set of lower dimensional embeddings.

14. The computer-readable medium of claim 13, wherein the configuration of spaced items is a configuration of compacted items.

15. The computer-readable medium of claim 14, wherein the configuration of compacted items has a centroid item at the center of the configuration of compacted items.

16. The computer-readable medium of claim 15, wherein the instructions, when executed by a processor of a computing system, further cause the computing system to:
prior to transforming the n-dimensional embedding from the n-dimensional embedding space to the lower dimensional embedding space:
obtain a first n-dimensional embedding corresponding to a first selected item, the n-dimensional embedding being in an n-dimensional embedding space, wherein the first-n dimensional embedding corresponds to the centroid item.

17. The computer-readable medium of claim 13, wherein the instructions, when executed by a processor of a computing system, cause the computing system to transform the n-dimensional embedding space to the low dimensional embedding space by:
applying a dimensionality reduction on the n-dimensional embedding space based on one or more features of the first n-dimensional embedding, to generate the low dimensional embedding space.

18. The computer-readable medium of claim 17, wherein the dimensionality reduction is:
a t-distributed stochastic neighbor embedding (t-SNE);
a uniform manifold approximation and projection (UMAP); or
a principal component analysis (PCA).

19. The computer-readable medium of claim 13, wherein the instructions, when executed by a processor of a computing system, cause the computing system to process the set of lower dimensional embeddings to generate a configuration of spaced items by:
arranging the set of lower dimensional embeddings in an quantized grid configuration.

20. An apparatus comprising:
a processing unit communicatively coupled to a display device, the processing unit being configured to:
transform an n-dimensional embedding from an n-dimensional embedding space to a lower dimensional embedding space, the n-dimensional embedding space containing a set of n-dimensional embeddings and the lower dimensional embedding space containing a set of lower dimensional embeddings transformed from at least a subset of the set of n-dimensional embeddings including the first n-dimensional embedding;
process the set of lower dimensional embeddings to generate a configuration of spaced items; and
transmit a signal to cause a display of a remote user device to output a navigational user interface (UI) having a plurality of selectable items according to the configuration of spaced items, the plurality of selectable items corresponding to lower dimensional embeddings of the set of lower dimensional embeddings.
